(19) United States
(12) Patent Application Publication
(10) Pub. No.: US 2012/0209560 A1
(43) Pub. Date: Aug. 16, 2012

(54) HUMAN MACHINE INTERFACE DEVICE

(76) Inventor: Joshua Michael Young, Hawker (AU)

(21) Appl. No.: 13/501,601

(22) PCT Filed: Oct. 22, 2010
(86) PCT No.: PCT/AU2010/001409

§ 371 Date: Apr. 12, 2012

(30) Foreign Application Priority Data
Oct. 22, 2009 (AU) 2009905136

(51) Int. Cl. G06F 15/00; G01P 3/00

(52) U.S. Cl. 702/141; 702/145; 702/150

(57) ABSTRACT

A hand operated input device including: a series of activation points activated by the fingers of a user; a motion sensor measuring a current orientation of the users hand and a processing means interconnected to the activation points and the motion sensors for output in a substantially continuous manner a series of currently active activation points and the current position and orientation of the input device.

### FIELD OF THE INVENTION

The invention generally relates to the field of user interfaces, and, in particular, discloses an input device for inputting data in a high fidelity manner.

### BACKGROUND OF THE INVENTION

Any discussion of the prior art throughout the specification should in no way be considered as an admission that such prior art is widely known or forms part of common general knowledge in the field.

Human machine input devices such as data gloves and hand mounted keyboards are known. For example, U.S. Pat. No. 6,429,854 is a multi-phalangeal input device with two touch sensors per digit or finger.

U.S. Pat. No. 4,776,253 describes using “ . . . linear or rotational velocity, acceleration, or time-derivative of acceleration . . . ” to control electronic musical sounds.

The Nintendo Wii system (eg U.S. Pat. No. 7,774,155) uses accelerometers and gyroscopes in data input. The Wii remotes also have buttons that can be used to elicit events with precise timing. However, the Wii remotes do not give the user rapid access to a wide range of discrete output events.

### SUMMARY OF THE INVENTION

It is an object of the present invention to provide an improved form of Human Machine Interface Device.

In accordance with a first aspect of the present invention, there is provided a hand operated input device including: a series of activation points activated by the fingers of a user; a motion sensor measuring a current orientation of the device, and a processing means interconnected to the activation points and the motion sensors for output in a substantially continuous manner a series of currently active activation points and the current position and orientation of the input device.

Preferably, the number of activation points per finger is at least two, with the activation points being spaced apart from one another for interaction with different portions of a user's finger.

In some embodiments, the number of activation points per finger can be at least 3. Preferably, a series of activation points is also accommodated for the thumb. The motion sensors can include orientation sensors sensing the rotational orientation of the device. In one example, the motion sensor outputs a roll, pitch and yaw indicator of the device. Further, the motion sensors can include position sensors sensing any relative movement of the device.

The device further preferably can include a weighted elongated portion counterbalancing the activation points when in use by a user. The relative position of the activation points can be adjustable for each finger. The activation points are preferably formed from microswitches. The processing means can be interconnected to a wireless transmission means for wireless transmission of the output. In various embodiments, each of the activation points can be actuated either individually or in combination with other activation points.

When utilised as a music input device, the activation points are preferably mapped to notes on a chromatic scale, one axis of the orientation of the device can be mapped to output the octave of a note's pitch, one axis of the orientation of the device can be mapped to a series of zones, and one axis of the orientation of the device can be mapped to audio volume.

In accordance with a further aspect of the present invention, there is provided at least two hand operated input devices, each device including: a series of activation points activated by the fingers of a user; a motion sensor measuring a current orientation of the users hand and a processing means interconnected to the activation points and the motion sensors for the orientation of the input device; wherein a further processing unit is provided interconnected to each processing means of each device and calculating a differential output between the hand operated input devices.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows the first embodiment of the interface from a front-left perspective.

FIG. 2 shows the first embodiment of the interface from the front-right perspective.

FIG. 3 shows the first embodiment of the interface from a lower-leftside perspective.

FIG. 4 shows a single finger triplet from a front-left perspective in isolation.

FIG. 5 shows a single finger triplet from the rear-rightside perspective in isolation with the side panels of the proximal and distal enclosures removed, and the top section of the medial enclosure removed.

FIG. 6 shows the triplet track and a triplet track connector in isolation from a front-left perspective.

FIG. 7 shows the thumb triplet in isolation from below with the lower portion of the thumb triplet's enclosure housing removed.

FIG. 8 shows a block diagram of the interface's electronics.

FIG. 9 shows a block diagram of the program used by the button sensor relay component of the electronics.

FIG. 10 shows a block diagram of the actuation sequence filter subroutine referred to in FIG. 9.

FIG. 11 shows a block diagram of the program used by the processor component of the electronics.

FIG. 12 shows example assignments of tone pitches to interface buttons.

### DETAILED DESCRIPTION OF THE PREFERRED AND OTHER EMBODIMENTS

In the preferred embodiments of the present invention there is provided an efficient form of data input device. The device achieves a large repertoire of discrete output signals and has excellent capabilities for utilization for musical purposes. The preferred embodiment allows for access to these discrete output signals as, for example, musical pitches. Used in this way the device is able to quickly access at least 15 musical pitches, and is also able to control the characteristics of these musical pitches. Furthermore, the user can quickly change the octave in which they play these 15 pitches. The preferred embodiment provides for the rapid, concurrent, and temporally precise access to these pitches, and thereby possesses strong melodic, harmonic, and rhythmic capacities.

Further, the preferred embodiment provides a system which allows the combination of melodic, harmonic, and rhythmic capacities with a means of motion and orientation sensing that is more precise, repeatable, intuitive, convenient, learnable, and is less costly.

Access to at least 15 pitches means the user can play through all the notes of standard divisions of the octave, for example the ‘western’ chromatic scale. Thus they can access all the diatonic scales derived from the chromatic scale (e.g. major and minor scales) without needing to change the assignment of notes to the interface. Due to this consistency, combined with the temporal-precision and repeatability of note-triggering, the preferred embodiment provides an eminently learnable system.

By way of initial background discussion, locations on the human hand and arm mentioned in the following description refer to an anatomical position of the right arm in which the upper arm hangs parallel to the upright body with the elbow bent, and with the forearm and hand horizontal to the ground and pointing forwards. In this position the forearm is pronated such that the palm of the right hand is facing the ground at a slight angle (i.e. with the palm lifted up slightly towards the user's body). A variety of angles could be used, and for this embodiment an angle of approximately 25 degrees from the ground plane is prescribed. In the following description this anatomical position will be referred to as the ‘neutral operating position’.

The interface's axes of roll, pitch, and yaw are defined approximately relative to the user's hand: With fingers outstretched in the same plane as the palm, rotating the hand and forearm around the axis of the middle finger is defined as rotating within the roll plane. Bending at the elbow is defined as moving within the pitch plane. Perpendicular to both the roll and the pitch planes is the yaw plane.

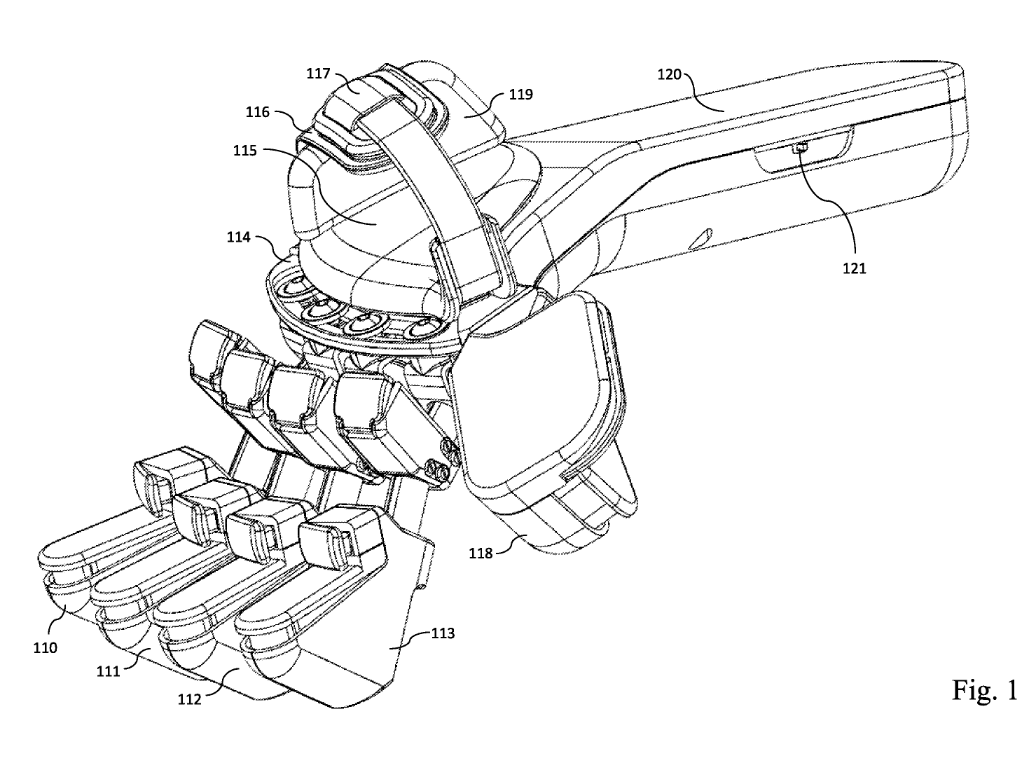

One embodiment of the interface is illustrated in FIG. 1 to FIG. 12. This embodiment is designed to interact with the right hand of the user, and the terms ‘left’ and ‘right’ used in this description are also defined relative to the user. Thus FIG. 1 shows the interface from a front-left perspective. At the front of the interface are four modules (110, 111, 112, and 113), each of which is referred to as a ‘finger triplet’. These finger triplets are positioned for operation by the little finger (110), ring finger (111), middle finger (112), and index finger (113) of the user's right hand respectively. Each finger triplet is connected to the rest of the structure by a rail or track 114 (the ‘triplet track’). This track is connected to a region of the structure, referred to as the ‘palm enclosure’ 115, which is designed to sit under the palm of the user's hand. Also connected to the palm enclosure 115 is a module, referred to as the ‘thumb triplet’ 118, which is positioned for operation by the thumb.

Attached to the right-hand side of the palm enclosure 115 and reaching over the top of the user's hand is a ‘palm clasp’ 116. Attached to the left-hand side of the palm enclosure 115 and reaching over the top of the user's hand is a ‘hand strap’ 117. The section of the hand strap attached to the palm enclosure is flexible and elastic. The lower surface of the opposite end of the hand strap attaches to the upper surface the palm clasp 116. As those skilled in the art would be aware, a variety of different mechanisms could be used to attach the hand strap to the palm clasp, including means like press studs or buckles, etc. In this embodiment a hook and loop mechanism can be used, and the areas of the hand strap and palm clasp covered by the hook and loop mechanism should be sufficiently large to allow the attachment position to be varied while maintaining a secure attachment. This variation allows the tightness of the attachment of the interface to the hand to be adjusted, however additional tightness adjustment means could also be used.

Sitting inside the palm clasp is a soft detachable cushioning section 119, referred to as the ‘hand clasp spacer’. Located behind the palm enclosure 115 is the ‘rear enclosure’ 120. Located on the rear enclosure is a power switch 121 for turning the electronics of the interface on and off. The rear enclosure is angled slightly downwards away from the plane formed by the top of the palm enclosure. This assists in preventing the rear enclosure from colliding with the user's forearm if the wrist is flexed. As it descends from the palm enclosure, the rear enclosure also falls slightly rightwards (relative to the palm enclosure). This angle is such that when the hand and arm are in the neutral operating position the rear enclosure of the interface lies beneath (rather than to the left) of the forearm.

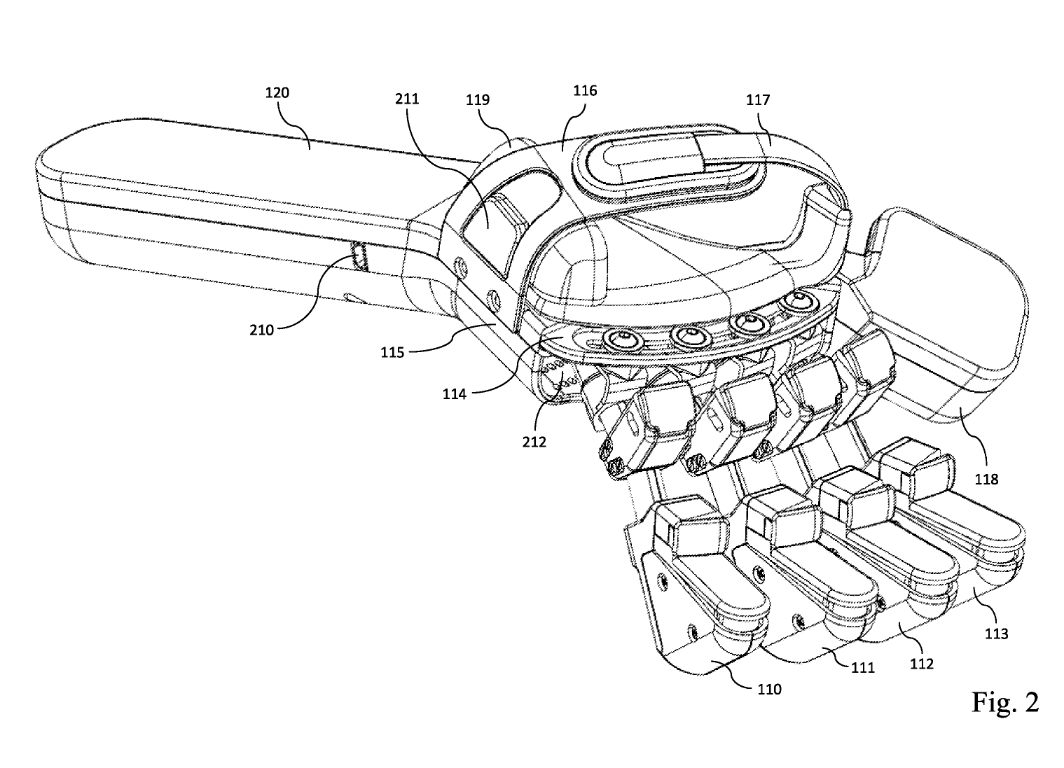

FIG. 2 shows the interface from a front-right perspective. Located on the right-hand side of the rear-enclosure 120 is a mini-B USB connector 210. Also evident in this figure is that the hand clasp spacer 119 is held in place by a protrusion 211 it projects into a frame formed by the hand clasp 116. The hand clasp spacer can be swapped-out for a different-sized spacer that projects more or less leftwards into the area above the palm enclosure 115, or the spacer can be removed entirely. In addition an opening 212 at the front of the palm enclosure acts as a recess for the rear-most sections of the finger triplets (110, 111, 112, and 113).

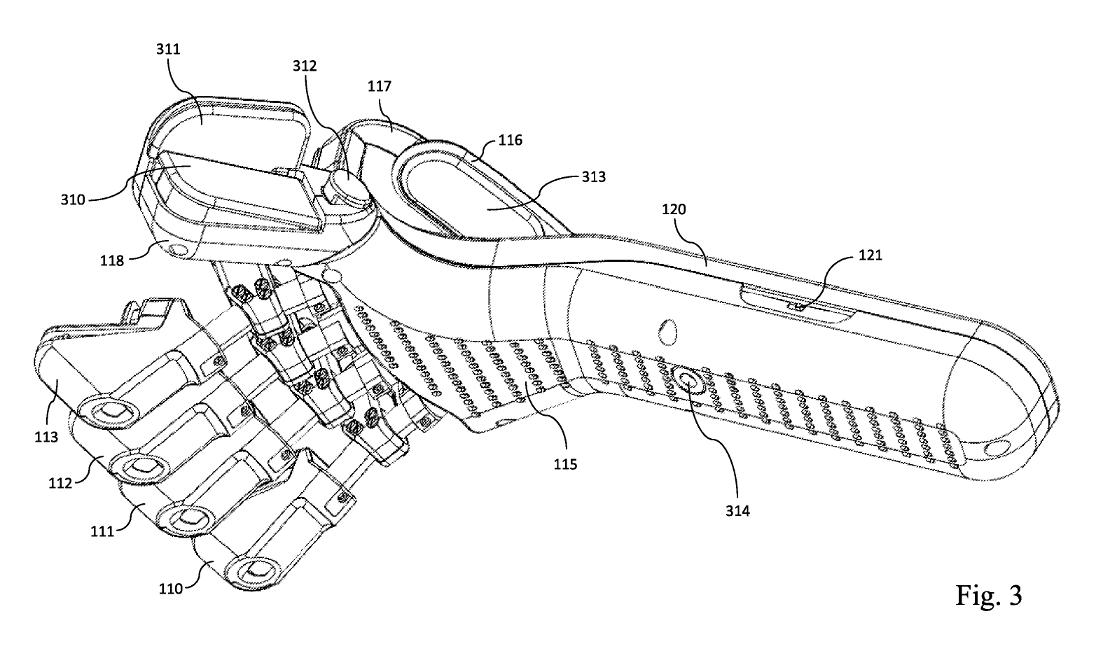

FIG. 3 shows the interface from a lower-leftside perspective. Located on the thumb triplet 118 are three buttons; a ‘distal’ thumb button 310, a ‘medial’ thumb button 311, and a ‘proximal’ thumb button 312. On the underside of the hand clasp 116 (the side that rests against the back of the user's hand) is soft padding 313. Located on the underside of the rear enclosure 120 is a socket for receiving a power cable 314.

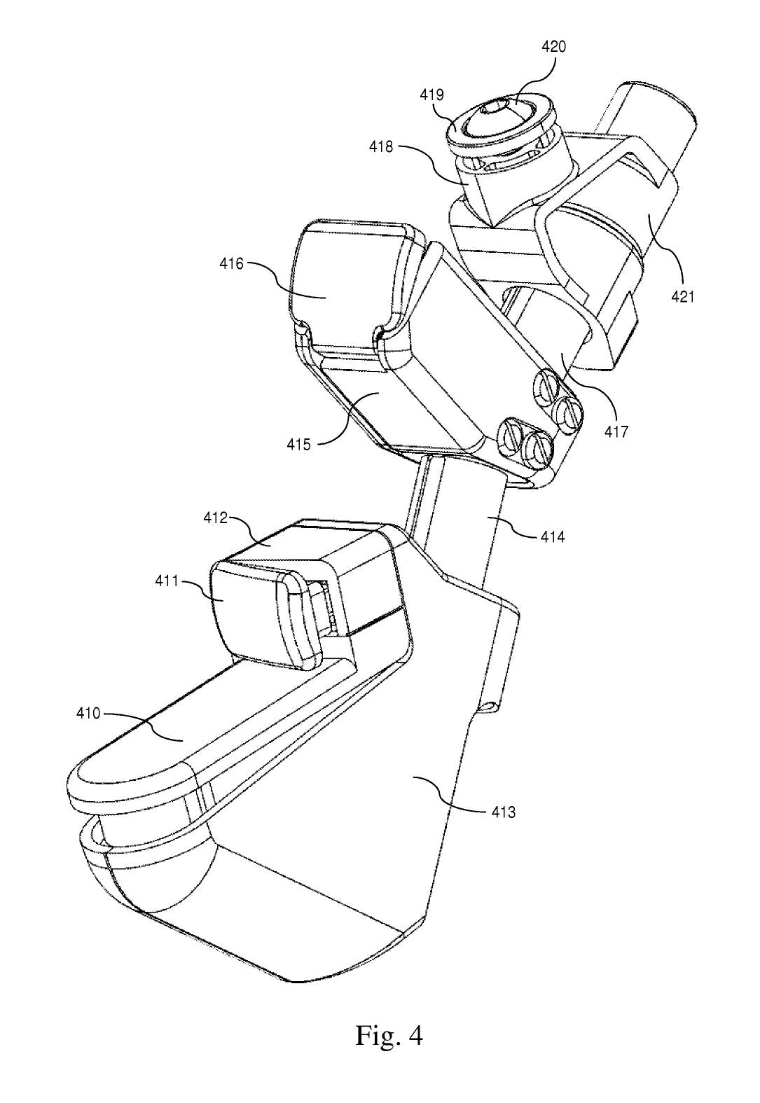

Illustrated in FIG. 4 is a finger triplet, from a front-left perspective, in isolation from the rest of the interface. In an example prototype embodiment all the finger triplets are identical in design. Similar to the thumb triplet, the finger triplet includes a distal finger button 410, a medial finger button 411, and a proximal finger button 416. The medial finger button is mounted in a combined structure formed by a ‘medial’ enclosure 412 and the rear portion of the distal finger button 410. The distal finger button is mounted in a ‘distal’ enclosure 413.

The distal enclosure is mounted on a ‘distal’ shaft 414, such that the distal enclosure can slide up and down, as well as around, the distal shaft. The distal shaft is connected to a ‘proximal’ enclosure 415, and the proximal enclosure is also the structure in which the proximal finger button 416 is mounted. The proximal enclosure is connected to a ‘proximal’ shaft 417. The exposed rear portion of the proximal shaft is mounted in a ‘triplet track connector’ 421, such that the proximal shaft can slide in and out of, as well as rotate within, the triplet track connector. On the upper portion of the triplet track connector is a cylindrical ‘triplet track connector clamp’ 418. Threaded into this clamp is a ‘connector bolt’ 420 and under the head of the bolt is a washer 419. In this embodiment it is contemplated that the upper end of the connector bolt can interface with, and can be tightened/loosened by, an appropriate sized Allen or Hex key. However, a variety of means for tightening and loosening the connector bolt could be used, including an outward protruding key head on the bolt that is accessible to, and can be manipulated by, the user's fingers.

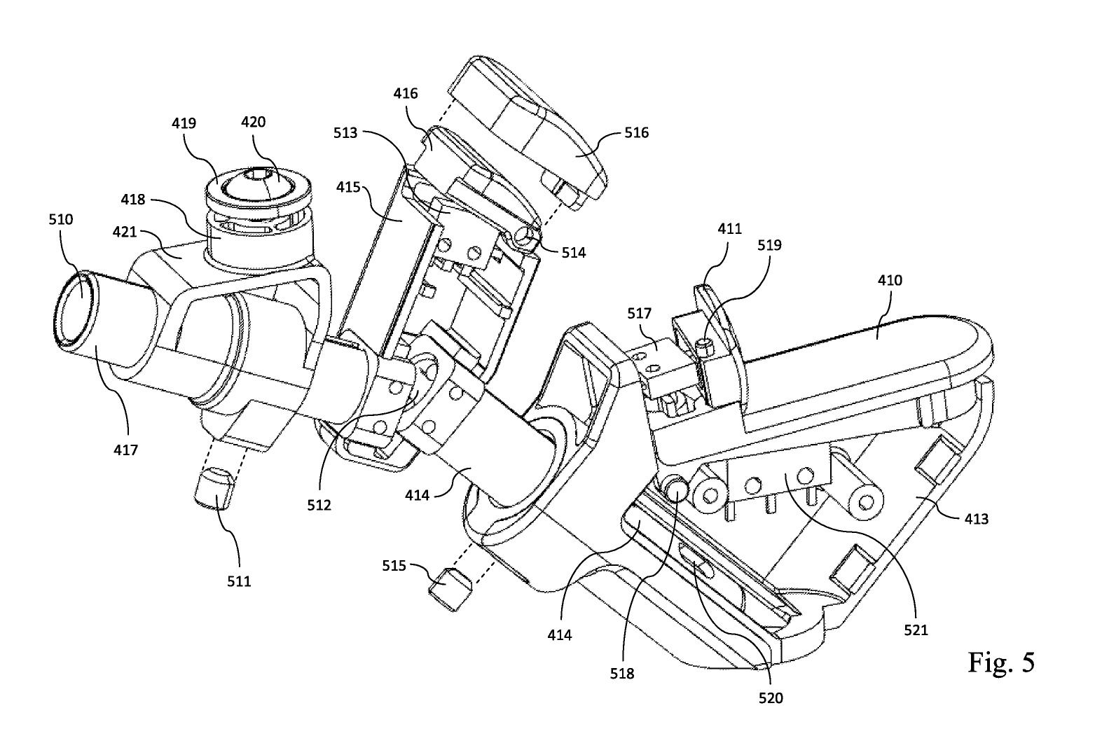

FIG. 5 again shows a finger triplet in isolation but from a rear-rightside perspective, with side sections of the proximal and distal enclosures removed, as well as the top section of the medial enclosure removed. The proximal shaft 417 and the distal shaft 414 are both hollow, allowing electrical wiring to enter the triplet at the rear-end 510 of the proximal shaft and exit at a portal 512 within the proximal enclosure or a portal 520 in the distal enclosure.

Also illustrated in FIG. 5 is a threaded bolt 511 that extends through the underside of the tubular section of the triplet track connector 421 (bolt thread not shown in figure). At the upper end of this bolt is a rubber plug that makes contact with the proximal shaft, thus screwing the bolt inwards acts to immobilise the proximal shaft relative to the triplet track connector. In a similar fashion a threaded bolt 515 extends through the underside of the distal enclosure 413 (bolt thread not shown in figure), and screwing the bolt inwards acts to immobilise the distal enclosure relative to the distal shaft. In this embodiment it is contemplated that the lower end of each of these bolts can interface with, and can be tightened/loosened by, an appropriate sized Allen or Hex key. However, a variety of means for tightening and loosening these bolts could be used, including a large outward protruding key head on the bolt that is accessible to, and can be manipulated by, the user's fingers.

A ‘proximal’ microswitch 513 is positioned for actuation by the proximal finger button 416. The micro switch can be used to provide operating and/or return force for the button, and/or haptic feedback indicating the trigger point has been reached. This is the case for all the microswitches and their respective buttons used in the finger and thumb triplets. Inserted into an axle cavity 514 and its matching axle cavity on the other side of the proximal finger button are axle protrusions from the proximal enclosure housing. These components form an axle mechanism around which the proximal finger button rotates during its actuation. Note that a method of reducing the relative force transmitted to the axle mechanism by the actuating finger can be used: As can be seen in FIG. 5, the height of the proximal button above the axle cavity 514 is reduced relative to the rear portion of the button. As a result, more of the force of the actuating finger is translated into the rear of the button than the front axle area, thereby making the button easier to actuate. The overall height of the button can also be adjusted with a removable ‘button cover’ 516. This cover can slide over the top of the proximal finger button and be kept in place by standard means (e.g. by friction between the cover and the button resulting from a tight fit, or a clipping mechanism formed by overhanging sections of the cover, etc). Once in place the cover would allow normal operation of the button, but with the contact surface now being closer to the actuating finger.

A ‘medial’ microswitch 517 is positioned for actuation by the medial finger button 411. The medial finger button axle protrusion 519 and its matching axle protrusion on the lower side of the medial finger button insert into axle cavities in the medial enclosure housing and the top of the distal button 410. These components form an axle mechanism around which the medial finger button rotates during its actuation. Note that in this embodiment the medial finger button uses the force-to-axle reduction method described for the proximal finger button above.

A ‘distal’ microswitch 521 is positioned for actuation by the distal finger button 410.

The distal finger button axle protrusion 518 and its matching axle protrusion on the other side of the distal finger button insert into axle cavities in the distal enclosure housing. These components form an axle mechanism around which the distal finger button rotates during its actuation. Because the medial enclosure and its respective microswitch and button are mounted on top of the distal finger button, actuation of the distal finger button also rotates the medial enclosure and it's components around the distal finger button's axle mechanism. Note that in this embodiment the medial finger button's finger-contact area is relatively thin (as measured between its top and bottom edges) and rounded. Note also that the finger-contact area of the distal finger button is relatively long, as measured from its axle mechanism to its front edge. All three microswitches on the finger triplet are orientated in such a way that their hinges are positioned towards the axles of their respective buttons, thus the microswitch levers actuate in the same arc as their respective buttons.

The positive, ground, and signal wires from the medial microswitch 517 descend through a cavity in the distal finger button into the distal enclosure 413. The positive and ground connections of the medial and distal microswitches are combined, and the positive, ground, and two signal wires enter the distal shaft via a wiring portal 520. The signal wires from the distal and medial microswitches extend back through the distal and proximal shafts to the wiring portal 510. The positive and ground connections of all three microswitches are combined in the proximal enclosure and, combined with the signal wire of the proximal microswitch, extend back through the proximal shaft to the wiring portal 510.

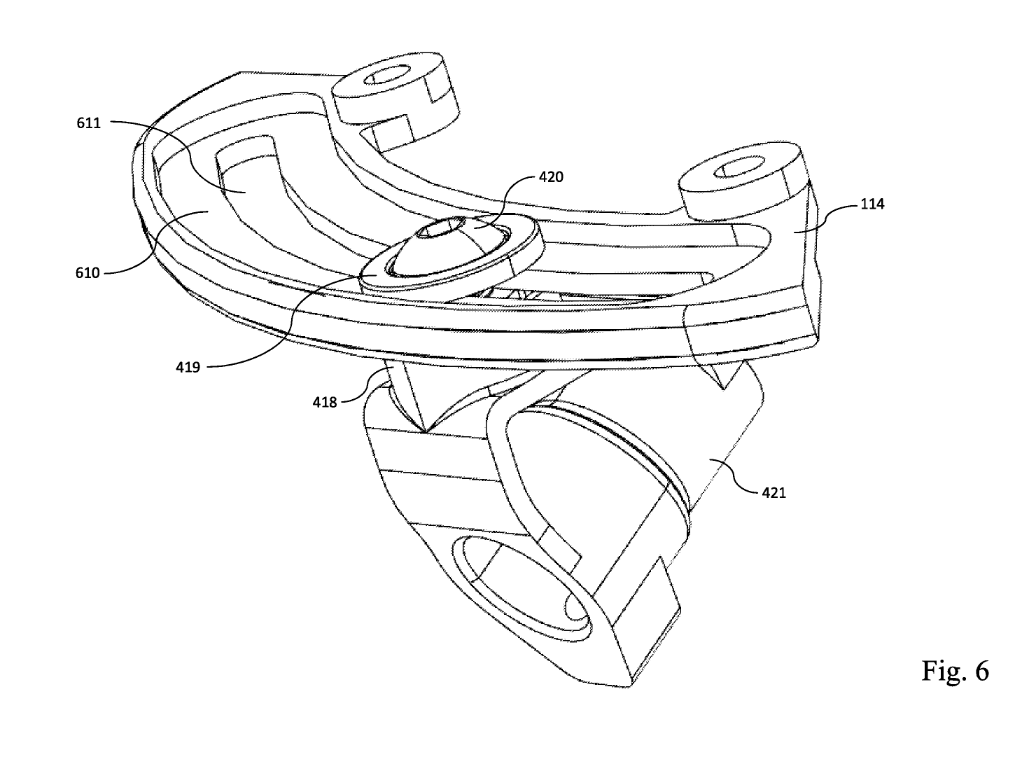

FIG. 6 shows the triplet track 114 and a triplet track connector 421 in isolation from a front-left perspective. There is a recessed fin section 610 within the triplet track against which the lower face of the connector bolt washer 419 and the upper face of the connector clamp 418 press. The connector bolt 420 passes through a channel 611 running between the fin parts on either side. Tightening the connector bolt presses the washer and the connector clamp against the fin parts 610, effectively immobilising the triplet track connector's location and orientation on the triplet track.

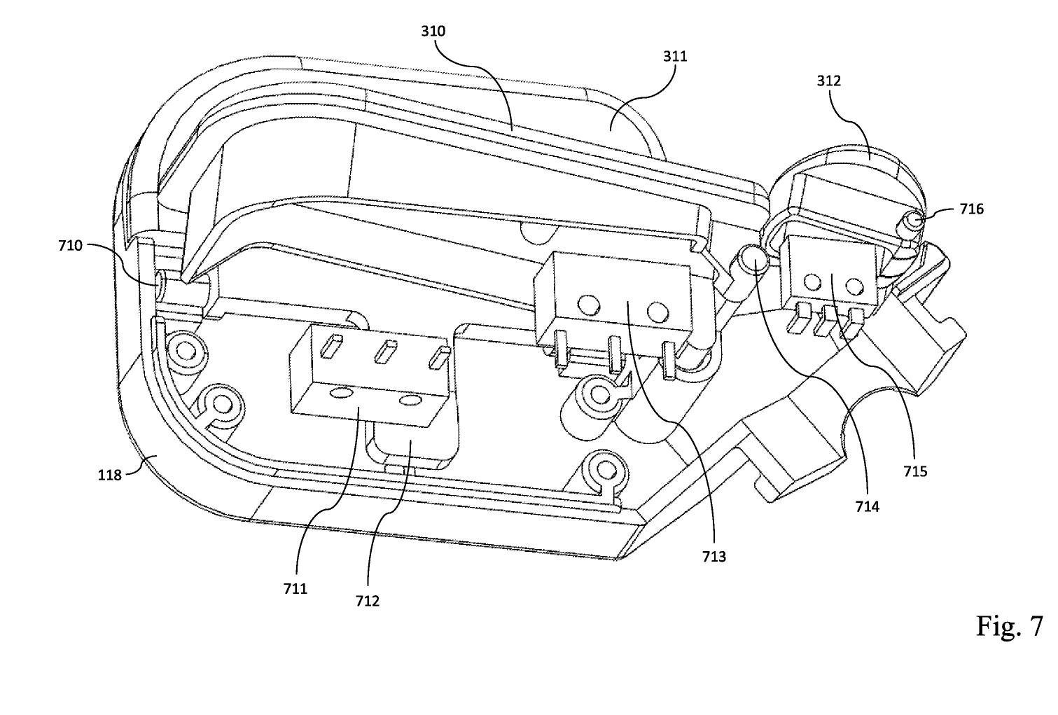

FIG. 7 shows the thumb triplet in isolation from below, with the lower portion of the thumb triplet's enclosure housing removed. The medial thumb button 311 has an axle protrusion 710. This protrusion, and its matching axle protrusion on the other side of the medial thumb button, insert into axle cavities in the thumb triplet enclosure housing. These components form an axle mechanism around which the medial thumb button rotates during its actuation. A ‘medial’ thumb microswitch 711 is positioned for actuation by an extension 712 of the medial thumb button. The extension is on the opposite side of the medial thumb button's axle mechanism, thus actuating (depressing) the medial thumb button rotates the extension towards the medial thumb microswitch. This microswitch is oriented such that the tip of its lever makes contact with the extension and the hinge of the microswitch is positioned towards the left of the interface (which in FIG. 7 is also towards the left of the figure), thus the microswitch lever actuates in an arc orthogonal to that of the extension.

A ‘distal’ thumb microswitch 713 is positioned for actuation by the distal thumb button 310. The distal thumb button axle protrusion 714, and its matching axle protrusion on the other side of the distal thumb button, insert into axle cavities in the thumb triplet enclosure housing. These components form an axle mechanism around which the distal thumb button rotates during its actuation. The distal thumb microswitch is orientated in such a way that its hinge is positioned towards the axle of the distal thumb button (i.e. towards the right of FIG. 7), thus the microswitch lever actuates in the same arc as the distal thumb button.

A ‘proximal’ thumb microswitch 715 is positioned for actuation by the proximal thumb button 312. The proximal thumb button axle protrusion 716 and its matching axle protrusion on the other side of the proximal thumb button 312 insert into axle cavities in the thumb triplet enclosure housing. These components form an axle mechanism around which the proximal thumb button rotates during its actuation. The proximal thumb microswitch is orientated in such a way that its hinge is positioned towards the axle of the proximal thumb button (i.e. towards the right of FIG. 7), thus the microswitch lever actuates in the same arc as the proximal thumb button. Note that in this embodiment the proximal thumb button uses the force-to-axle reduction method described for the proximal finger and medial finger buttons above. While not illustrated in FIG. 7, this button can also incorporate a removable button cover (as described for the proximal finger button above) to adjust the distance of the contact surface of the button from the thumb.

Returning to FIG. 1, in this embodiment the rear enclosure 120 is designed to house electronics and to use the weight of these electronics and its own structure to act as a counterweight against the weight of the interface's sections that are positioned in front of the user's wrist. This counterweight effect can be used to modify or eliminate the muscular activity required by the user wearing the interface to keep their wrist straight in the neutral operating position (as defined in the beginning of the description). Where the balance point (the place where the interface can be suspended from and remain in balance) between the front and the rear of the interface lies will depend on a variety of factors including the weight of materials used in construction, the length of the rear enclosure, and the placement of components within the rear enclosure. A wide range of balance points could be utilised, and for this embodiment it is contemplated that the balance point should lie approximately at the middle of the user's palm (i.e. approximately the middle of the palm enclosure 115).

The electronics located in the rear enclosure are required to perform two main tasks. The first task is converting the signals coming from the button sensors into a single digital data stream that can be passed on to an external device in a useful form (as described above, in this embodiment the button sensors for the distal, medial, and proximal buttons of the thumb and finger triplets are be micro switches). The second task is that of measuring the interface's motion and orientation and passing these measurements on to an external device in a useful form.

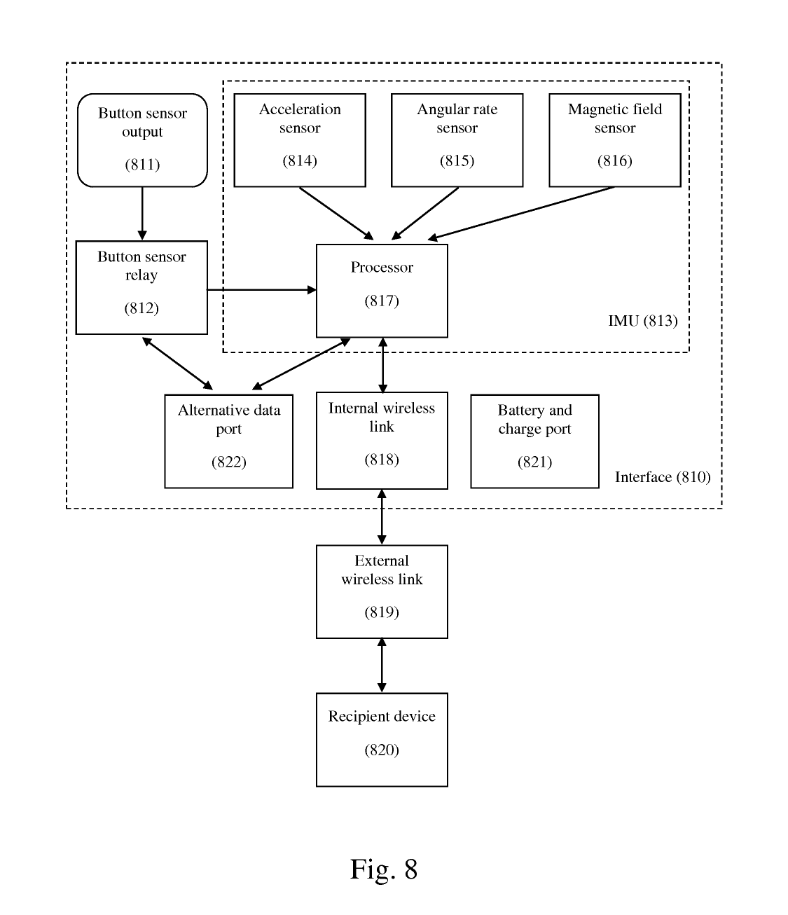

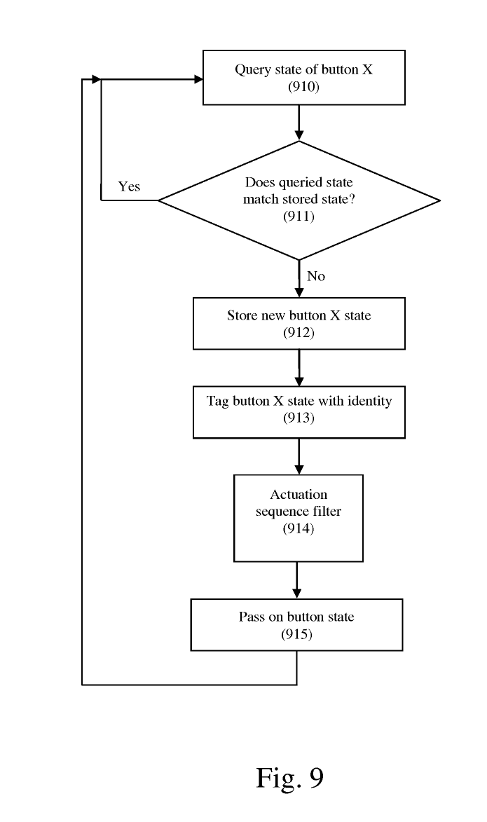

FIG. 8 illustrates a functional block diagram of this embodiment's electronics. Signals from the button sensors 811 are passed on to a relay 812 that has multiple input channels. This relay then converts these multiple input signals into a single digital data stream which is passed on to a processor 817. As would be clear to those skilled in the art a variety of devices could perform the functions required of this relay. For example, in this embodiment a commercially-available single-board microcontroller Arduino Nano 3.0—ATMEGA328, available from Gravitech of Claremont, Calif., USA (see http://yhst-27389313707334.stores.yahoo.net/arna30wiatp.html) is suitable. For button sensors in the form of microswitches, this microcontroller board can supply the required positive and ground connections as well as the necessary signal channels (through a combination of its available digital and analog channels). This board is also able to pass on the collected button sensor data via its output serial port (TX pin). The type of program that can be run on this microcontroller board to perform its task is illustrated in FIG. 9 and described below.

Also illustrated in FIG. 8 are the electronics of this embodiment that are used to measure the interface's motion and orientation. These components include three types of sensors: (1) A sensor that measures the interface's dynamic and static gravity acceleration in three dimensions 814, (2) a sensor that measures the angular rate of the interface's rotation around the pitch, yaw, and roll axes 815, and (3) a sensor that measures magnetic fields around the interface in three dimensions 816. The data from these three sensor types is then passed on to the processor 817 that can convert the data into a form that is appropriate for transmitting to an internal wireless link 818. As would be understood by those skilled in the art, a variety of means for performing the functions of these sensors (814, 815, and 816) and the processor 817 are available. For example, for this embodiment an integrated inertial measurement unit 813 is suitable. One example of such a unit is the commercially-available 9DOF Razor IMU produced by SparkFun Electronics of Boulder, Colo., USA (see http://www.sparkfun.com/commerce/product_info.php?products_{—}=9623). This unit is able to receive data from the button sensor relay 812 via its input serial port (RX pin). This unit is also able to process and pass its accelerometer/gyroscope/magnetometer data along with the button sensor data on to the internal wireless link 818 via its output serial port (TX pin). If it assists in optimising the performance of the motion/orientation sensors they can be housed within the rear enclosure with a specific orientation. For example, they (or an entire inertial measurement unit as described above) can be oriented within the rear enclosure such that they are approximately horizontal to the ground when the interface is in its neutral operating position (as defined in the beginning of the description).

FIG. 8 shows that the wireless link 818 is internal to the interface 810 and wirelessly transmits the combined button sensor and motion/orientation sensor data to a wireless link 819 that is external to the interface. This external wireless link then transfers the data it has received to a recipient device 820. As those skilled in the art would be well aware, any number of wireless systems would be suitable for acting as the internal and external wireless links, and for this embodiment one example is to utilize the Xbee modules available from Digi International of Minnetonka, Minn., USA. Additional standard components are required to pass data to and from these modules in an appropriate form, and assembled conversion devices are commercially-available, for example those supplied by SparkFun Electronics of Boulder, Colo., USA or Adafruit Industries of New York, N.Y., USA. Note that the wireless link components 818 and 819 can be made additionally capable of transferring data from the recipient device to the interface. This would allow, for example, program change commands to be sent to the button sensor relay 812 and/or processor 817. As would be understood by those skilled in the art, such an arrangement would require additional electronics to manage the bi-directional communication of the internal wireless link with the button sensor relay and/or the processor.

Data from the interface can be made use of by any number of devices, and in this embodiment the recipient device 820 shown in FIG. 8 is a computer or mobile computing device. In this embodiment the recipient device can receive the interface's data via a cabled connection from the external wireless link 819, and is running music software. The data received from the interface can be used to control aspects of this software, the playing of software-based musical sounds being but one example. This software could be one of the many commercially-available music software programs on the market, or it could be a program provided specifically for use with the interface. The external wireless link would perform whatever conversion is required to make the interface's data usable by the computer. For example, the external wireless link could act as a USB MIDI device that converts the interface's data to MIDI data that could then be used by the recipient device's software by standard means. Alternatively the external wireless link could provide the data in another format (e.g. using the USB connection as a serial port) and an additional program could be installed on the recipient device for accessing this data and providing it to be used by other programs on the recipient device.

The user would also have the option of using a left-handed version of the interface (essentially a mirror image of the right-handed version) and using right- and left-handed versions simultaneously. In this latter instance the data from the two interfaces could be passed on to the recipient device 820 (see FIG. 8) via the same external wireless link 819. Aside from the additional interface data coming from the left-handed version, an extra type of data can also be generated through a comparison of the actions of the two interfaces (e.g. the difference in pitch angle, or the difference in the buttons being actuated, etc). In this scenario, algorithms for processing such comparative data can be included in a program running on the recipient device, or by an additional processing component included on the external wireless link.

Also illustrated in FIG. 8 is a battery 821 that would provide all the electricity required by the interface's electronics, the supply of which would be gated by the power switch 121 (see FIG. 1). Depending on the battery's voltage, standard means of voltage conversion may be required for supplying an appropriate voltage to the interface's components. While a variety of battery types can be used, for this embodiment the battery should be a rechargeable lithium polymer type, which can be charged by a standard charging device (using conventional means of supply) that is connected to the external power socket 314 (see FIG. 3). Alternatively a replaceable battery system can be used, with a standard convenient means of swapping the battery/batteries in and out of the rear enclosure.

The final component illustrated in FIG. 8 is an external port 822 that could be incorporated as part of an alternative embodiment of the interface. This port, which would connect to an external data cable, can be used for data communication with, and updating the software of, the processor 817 and/or the button sensor relay 812. Any number of devices can achieve this function, including components that convert USB signals to serial port signals, like those available from Future Technology Devices International of Glasgow, United Kingdom. As shown in FIG. 2, a mini-B USB connector 210 can act as the connector for port 822. A cable connected to the port 822 can act as the communication link to the recipient device 820 and perform the task of the wireless components 818 and 819. This cable can also supply power to the interface from the recipient device, to power the interface's electronics and/or to charge its battery. Thus an alternative embodiment is possible, that includes a cable-dependent interface requiring no onboard battery and/or wireless link system.

A block diagram of the program that can be run on the button sensor relay 812 (see FIG. 8) is illustrated in FIG. 9. The purpose of this program is to collate the signals from the multiple button sensor inputs to the relay, and report button sensor state changes to the processor 817 via a single data-channel. The program continuously cycles through all the iterations required to query the state of each button sensor, where X=1, 2, . . . Xtotal, and Xtotal is the total number of button sensors. After querying the state of button sensor X (910), this state is compared to the previous state of button sensor X (911) stored in memory from the previous cycle through X. If the state is the same the program iterates to X+1 and returns to step 910. If the queried X state does not match the stored X state, the queried state becomes the stored X state (912). Then a value or value set is created that represents the X state and identifies this state as being associated with button sensor X (913). This identification can be achieved in a variety of ways, including representing each button sensor with one of two possible unique values. For example, button 1 could be represented as unactuated with a value of 0 and actuated with a value of 15, while button 2 could be represented as unactuated with a value of 1 and actuated with a value of 16, and so on. A filtering step 914 then takes place which will be described in detail in the next section. Depending on the actions of the filter, the new tagged state value of button X is then passed on (915) to the next component, which in this embodiment is the processor 817 (see FIG. 8). The program then iterates to X+1 and returns to step 910.

The forms and positioning of the distal finger button 410 and proximal finger button 416 (see FIG. 4) belonging to the same triplet allow their assigned finger to actuate them either individually or in combination with each other. This is also the case for the distal finger button and medial finger button 411 belonging to the same triplet. The purpose of the actuation sequence filter 914 shown in FIG. 9 is to allow the output events assigned to the medial and proximal finger buttons of a triplet to be used in combination with each other through specific sequences of button actuation. By doing so, every possible combination of simultaneous ‘on’ signals among a finger triplet's three buttons becomes possible. A detailed description of how this functionality can be used is provided in the Operation section. The actuation sequence filter can also be applied to signals originating from the thumb triplet, but this is less necessary as all thumb button combinations can be achieved manually.

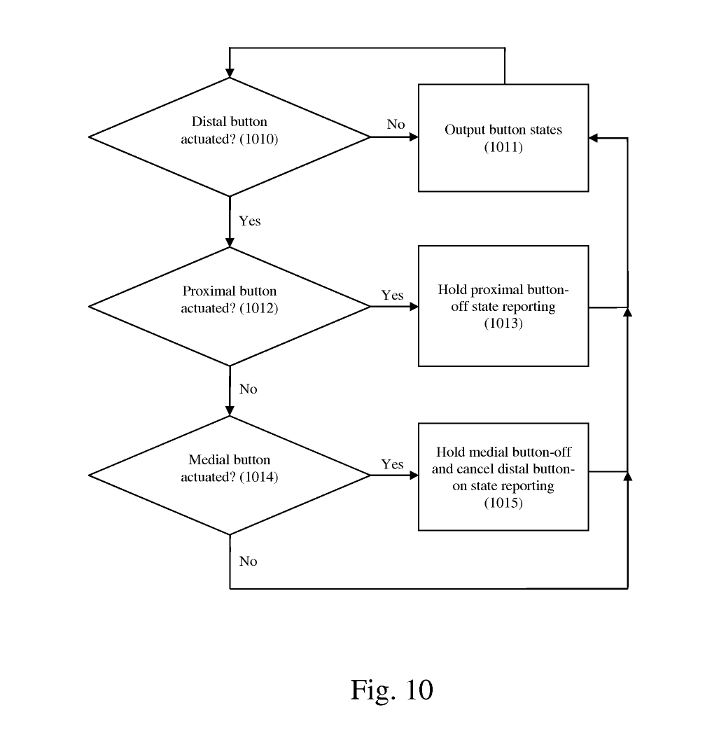

This actuation sequence filter subroutine could be achieved via a variety of means, and one method for this embodiment is illustrated in FIG. 10. The subroutine begins when a new button state is received and it checks whether the new state belongs to any of the distal finger buttons (1010). If not, the new data is passed out of the subroutine (1011), without any filtering, to the next stage of the program (915) illustrated in FIG. 9. If the new state was triggered by a distal button the subroutine checks whether the stored state of the proximal button belonging to the same triplet is as actuated (1012). If yes, the filter will ‘hold’ any report of the proximal button changing to an unactuated state, but will pass on the most recent such ‘held’ report when the distal button of that triplet is unactuated (1013). Meanwhile, the actuated state of the distal button is passed out of the subroutine (1011). If the proximal button is not actuated, the subroutine checks whether the stored state of the medial button belonging to the same triplet is as actuated (1014). If yes, the filter will hold any report of the medial button changing to an unactuated state, but will pass on the most recent such ‘held’ report when the distal button of that triplet is unactuated (1015). In addition, this report of the distal button being actuated will not be passed on and no reports of its actuation will be passed on until the distal and medial buttons are unactuated (1015). After the distal and medial buttons are unactuated, subsequent reports of distal button actuation will be allowed through the filter. If the answer at step 1014 is no, the distal button actuation report is passed out of the subroutine (1011), without any filtering, to the next stage of the program (915) illustrated in FIG. 9. The use of this subroutine can be made optional, with its activation being controlled using physical controls on the interface or via commands sent from the recipient device 820 via the wireless link system (see FIG. 8).

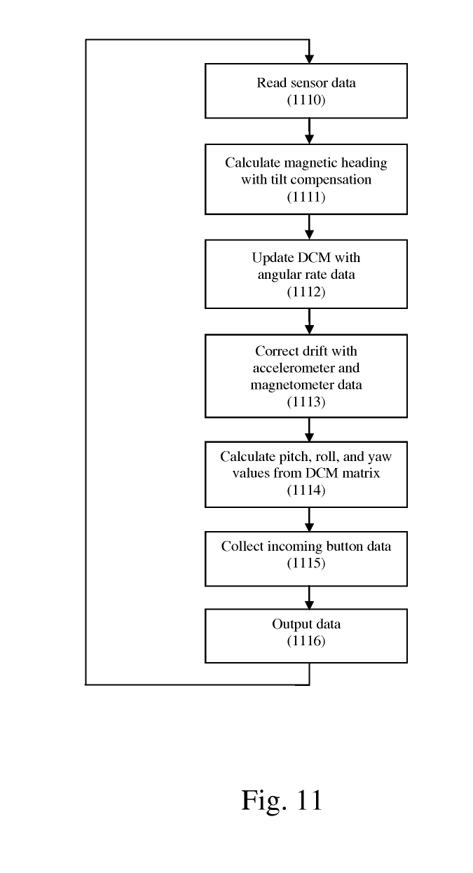

In this embodiment the accelerometer, gyroscope, and magnetometer data are used to estimate the interface's orientation in the pitch, roll, and yaw axes. This task can be performed by software running on a processor 817 (see FIG. 8). As is well understood by those skilled in the art, there are a variety of techniques that can be used to combine the output of these different sensor types to produce orientation estimates (pitch, roll, and yaw). For example, in this embodiment a technique that utilises a ‘direction cosine matrix’ can be used, with a program structure like that described in FIG. 11. Software of the kind described in FIG. 11 is well understood by those skilled in the art and the program that forms the basis of what is described for this embodiment can be found at: http://code.google.com/p/sf9domahrs/downloads/list.

As illustrated in FIG. 11 the initial step in this program is to read the accelerometer, gyroscope, and magnetometer data from the relevant sensors (1110). The current estimates for pitch and roll (provided by the previous iteration or initialised at program start) are then used to compensate for the effect on magnetometer readings of the magnetometer not being orthogonal to the ground, and then a heading is calculated relative to the Earth's magnetic field (1111). Angular rate (i.e. gyroscope sensor) values are then used to update the direction cosine matrix (DCM) values (1112). Corrections are then made to ensure that the estimated reference axes (x, y, and z) for the interface remain orthogonal to each other, then the accelerometer and magnetometer data are used to correct errors that have developed over time in the angular rate-based direction cosine matrix values (1113). The direction cosine matrix values are then translated into estimates of pitch, roll, and yaw (1114). The button states, provided by the button relay 812 (see FIG. 8), are then collected (1115). Then the button and motion/orientation data is outputted (1116) to the internal wireless link 818 (see FIG. 8). A variety of motion/orientation data combinations could be outputted to the internal wireless link. For example, in this embodiment the combination includes; button state values, pitch, roll,and yaw orientation values, as well as angular rate of rotation (gyroscope) and acceleration (accelerometer) values in all three measurement axes.

### Operation

As shown in FIG. 1, FIG. 2, and FIG. 3 there are fifteen touch-activated buttons located on the interface and three buttons are assigned to each digit (the fingers and thumb). Each of these groups of three buttons, referred to as a ‘triplet’, is ergonomically positioned along the main plane of flexion of a single digit. As part of the normal operation of the interface, each digit is only required to interact with one triplet of buttons.

As is evident in FIG. 1 and FIG. 2 the user's right hand is placed between the palm enclosure 115 and the hand clasp 116 and the hand strap 117 is attached to the upper surface of the hand clasp at a position that causes the interface to remain firmly but comfortably attached to the hand despite the arm and hand being moved around in space. The palm is positioned such that the user's little, ring, middle, and index fingers can comfortably access the buttons on the finger triplets 110, 111, 112, and 113, respectively. The user's thumb is positioned so it can comfortably access the buttons on the thumb triplet 118. To provide a close fit to the user's hand the hand clasp spacer 119 can be swapped for one of a different size or removed entirely.

As can be seen in FIG. 4, the distal finger button 410 and medial finger button 411 are positioned to be actuated independently or concurrently through contact with the finger's tip segment (distal phalanx). Actuation of the distal finger button is achieved mainly through flexion at the finger's middle knuckle (proximal interphalangeal joint) and/or base knuckle (metacarpophalangeal joint). Actuation of the medial finger button 411 occurs through curling the finger, mainly via flexion at the top knuckle (distal interphalangeal joint) and middle knuckle. The proximal finger button 416 is positioned to be actuated by the middle and/or base segments of the finger (intermediate and proximal phalanges). Actuation of the proximal finger button occurs mainly via flexion at the base knuckle. In this embodiment the operation of each finger triplet for all four fingers is more or less identical.

As shown in FIG. 3, the distal thumb button 310 and medial thumb button 311 are positioned to be activated independently or concurrently by movement of the thumb's tip segment (distal phalanx). Actuation of the distal thumb button is achieved mainly through flexion at the top knuckle (distal interphalangeal joint). Actuation of the medial thumb button is actuated by movement (adduction) of the thumb towards the hand, which occurs mainly by flexion at the base knuckle (metacarpophalangeal joint) and/or the joint connecting the thumb to the hand (carpometacarpal joint). The proximal thumb button 312 is positioned to be activated by the base segment (proximal phalanx) and/or palmar segment (metacarpal) of the thumb. Actuation of the proximal thumb button occurs mainly via flexion at the base knuckle and/or the joint connecting the thumb to the hand.

In order for the user to be able to comfortably and effectively operate all the triplet buttons on the interface a variety of mechanisms are present for adjusting the locations and orientations of these buttons. To accommodate a range of hand widths, the location of each finger triplet on the triplet track can be adjusted. As is illustrated in FIG. 6 this is achieved by unscrewing the connector bolt 420 until pressure of the washer 419 and the connector clamp 418 against the channel fin parts 610 is reduced enough for the position of the triplet track connector 421 (and the rest of the triplet) along the length of the track 114 to be altered. Loosening the connector bolt in this way also allows the rotation of the triplet track connector, relative to the triplet track, to be adjusted. When the desired location and rotation of the track connector is achieved the track connector can be immobilised again by re-screwing the connector bolt.

As shown in FIG. 5, further adjustment of the locations and orientations of a finger triplet's buttons is made possible when the user unscrews the proximal shaft bolt 511 and/or the distal shaft bolt 515. By unscrewing the proximal shaft bolt 511, pressure on the rubber pad lying against the proximal shaft 417 is relieved, and the proximal shaft is able to slide forwards and rearwards within the tubular section of the triplet track connector 421. In so far as is possible without colliding with the neighbouring finger triplets, rotation of the proximal shaft within the triplet track connector can also take place. By unscrewing the distal shaft bolt 515 the distal enclosure 413 is able to slide up and down the distal shaft 414. Rotation of the distal enclosure can also take place, but the presence of wiring at the distal shaft wiring portal 520 restricts the range of that rotation. Screwing the bolts 511 and 515 back into position will immobilise the triplet sections in their new adjustment positions. An additional form of adjustment available to the user is varying the distance of the contact surface of the finger and thumb triplet proximal buttons from their actuating digits through the use of button covers, as is illustrated by the proximal finger button cover 516 in FIG. 5.

As described previously, the forms and positioning of the distal and medial buttons belonging to the same triplet allow these buttons to be actuated either individually or in combination with each other by a single digit. In a musical application of the interface where the buttons are used to trigger musical tones, such combinations would allow specific harmonies to occur, thereby extending the range of harmonies that can be produced beyond that of combinations of buttons belonging to separate triplets. In the case of the finger triplets (see FIG. 4), the reason for this is that the contact surface of the medial finger button 411 is curved and relatively thin (measured between its top and bottom edges) and mounted on top of the distal finger button 410. As a result the user can, while maintaining actuation of the medial finger button, push down (on the distal and/or medial finger button) and actuate the distal finger button. Vice versa, the user can, while maintaining actuation of the distal finger button, pull their finger back and actuate the medial finger button.

The distal and proximal finger buttons belonging to the same triplet can also be actuated either individually or in combination with each other by a single digit. The distal button's length means that the user can actuate it with either a partially curled or outstretched finger. In the latter case the lower pad of the finger's distal segment (distal phalanx) makes contact at the front end of the button. This posture makes it easier for the user to maintain actuation of the distal button while actuating the proximal button and vice versa.

In order to allow the outputs of the medial and proximal finger buttons to be used together, the user has the option of having each triplet's sequence of button activation algorithmically interpreted in real-time to selectively allow the combination of the medial and proximal button output events to occur. In the first component of this actuation sequence filter subroutine 914 (see FIG. 9 and FIG. 10), maintaining actuation of the proximal button while actuating the distal button allows the output signal of the proximal button to be sustained despite the proximal button being released (steps 1010, 1012, and 1013 in FIG. 10). While the distal button remains actuated the output signals of the distal and proximal buttons will be sustained concurrently. While keeping the distal button actuated, the user can then actuate the medial button, thereby causing the output signals of the distal, medial and proximal buttons to be sustained concurrently. In the second component of this subroutine, if the distal button is actuated after the medial button is actuated (while the medial button's actuation is maintained) then the distal button's output signal will not trigger a response (steps 1010, 1014, and 1015). If the medial button is then released while actuation of the distal button is maintained, then the output signal of the medial button will continue uninterrupted. The user can then actuate the proximal button, while keeping the distal button actuated, thereby allowing the output signals of the medial and proximal buttons to be sustained concurrently.

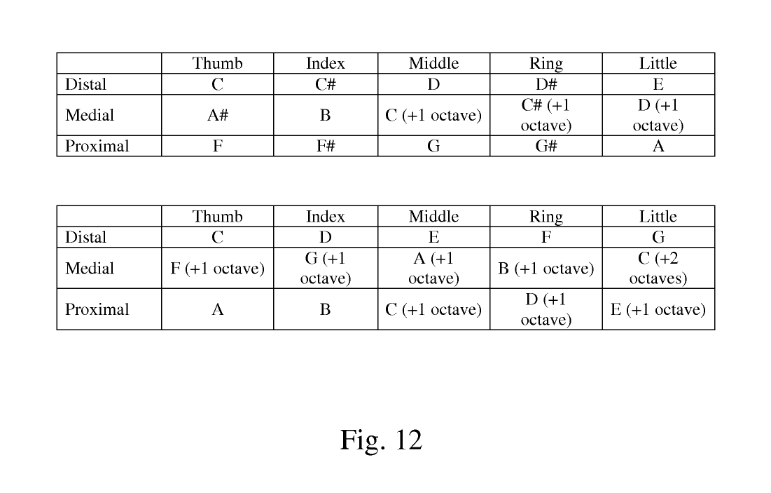

In this embodiment the proximal, medial, and distal buttons of the finger triplets and thumb triplet have the principal function of providing discrete on and off signals that can be translated by the recipient device 820 (see FIG. 8) into sounds, such as musical tones. For example, each of the fifteen buttons could be assigned to one of the twelve tones of the chromatic scale, with the remaining three buttons assigned to notes above or below the chosen octave. Alternatively, two octaves of a diatonic scale could be assigned to the fifteen buttons. Examples of such arrangements are shown in FIG. 12. The upper table shows an example of a chromatic arrangement: Starting at a C note on the distal thumb button, the notes ascend first through the distal buttons, then through the proximal buttons, then through the medial buttons, finally reaching a D note (one octave higher) on the medial button of the little finger triplet. The lower table shows an example of a diatonic arrangement (a C major scale): Starting again at a C note on the distal thumb button, the notes ascend first through the distal buttons, then through the proximal buttons, then through the medial buttons, finally reaching a C note (two octaves up) on the medial button of the little finger triplet. Regardless of the note assignment used, the positioning of the interface's buttons allows the user to produce harmonic combinations of those notes, as well as melodic sequences.

This embodiment of the interface could provide the user with a variety of options with regard to how the interface's angular rate, orientation (pitch, roll, and yaw), and acceleration data are utilised by the recipient device 820 (see FIG. 8), including using them to modulate the recipient device's processing of input from the interface's buttons. One option, for example, is where the recipient device responds to button input by producing tones resembling those of a sustained-tone instrument (e.g. cello or flute), and the angular rate of interface rotation around the yaw and/or pitch axes is used to emulate the effect of bowing or blowing intensity on these tones. In this example the user could be generating changes in the rate of angular rotation in the yaw plane by swinging the interface from side to side (from the neutral operating position), mainly by rotation at the shoulder joint and bending at the elbow. Should the user wish to use a right- and left-handed version of the interface simultaneously, they could also be provided with a variety of options for utilising the comparative data of the two interfaces. For example, actuation of a button on one interface could select the starting frequency of a note and actuation of a button on the other could select the end frequency, and reducing the orientation difference between the two interface's (for example, in the pitch axis) could slide the frequency from the start frequency to the end frequency.

In another example of user control, this embodiment could also provide the user with an octave pitch-control option based on interface orientation. This option would control the octave value of the tones triggered by the buttons. In this option the user can choose one of the orientation axes, for example the pitch axis, to be divided into multiple zones. If a total of three angle zones around the pitch axis were chosen (e.g. down, middle, and up) then the pitch of the interface relative to these zones would determine the octave values of the notes triggered by the buttons. For each note triggered, three tones in three adjacent octaves are produced simultaneously, but their respective volumes are determined by the interface's pitch angle relative to the down, middle, and up zones at the time of triggering. For example, actuating a button corresponding to the note C while the interface is in the down zone might be set up to trigger the notes C3, C4, and C5, but only C3 would have an audible volume. The user could be given the option of attributing crossfaded volumes to the borders of these zones, such that actuating the C button near the border of the down and middle zones would again trigger the C tone in all three octaves but both the C3 and C4 tones would have an audible volume. The user could also be given the option of using this octave control in a dynamic or constant mode. In the dynamic mode maintaining activation of the C button while moving the interface from the down zone to the middle zone would dynamically crossfade the volumes of the C3 and C4 tones, such that the former would fade and the latter would increase. In the constant mode, tones retain the zone-based volume level assigned at the time they were triggered, thus actuation of the C button in the down zone followed by moving the interface to the middle zone would result in the volume of the C3 tone being maintained at the same level throughout the movement. The processing required to perform the pitch-control described above could be performed by a variety of components including the processor 817 (see FIG. 8), a processing component added to the external wireless link 819, or an additional program installed on the recipient device 820.Alternative embodiments.

A number of modifications to the described embodiment are possible. In an alternative utilization of the interface the recipient device 820 (see FIG. 8) could be a device on which the user can play a video game (e.g. the Microsoft Xbox, Sony playstation, Nintendo Wii, or a personal computer/mobile computing device, etc) where the user participates in the game through their operation of the interface. Alternatively the recipient device 820 could act as a data-entry device (e.g. a personal computer or mobile computing device, etc), where the range of different discrete output signals the interface can produce are mapped to a specific data set (e.g. letters, numbers, etc). In this embodiment the range of different output signals the interface can produce could be expanded beyond what can achieved by actuating individual buttons by making the events triggered by button actuation dependent on the interface's orientation and/or motion (in a similar way to the octave pitch-control option described in the first embodiment). Another means of expansion would be to trigger additional specific events through specific combinations of button actuation. Equipment that is designed to generate musical sounds in response to external commands (e.g. MIDI messages) could also act as the recipient device, hardware synthesisers being but one example.

An alternative embodiment of the interface could include a different number of finger triplet buttons and/or a different arrangement of those buttons. For example, an embodiment could include only distal buttons 410 (see FIG. 4) and medial buttons 411, with no proximal buttons 416. Or an embodiment could include only distal and proximal buttons, with no medial buttons. Alternatively, more than three buttons per digit could be provided on the interface. Such additional buttons could be positioned to be actuated through sideways movement of the digit, or extension of the digit. Another alternative embodiment could be designed without a thumb triplet 118 (see FIG. 1), and the thumb could be given the task of keeping the interface in contact with the hand, via an appropriate structure against which the thumb could grip or press.

Button sensors with more detailed measurement capabilities could be used in an alternative embodiment. For example, instead of microswitches the buttons of the finger and thumb triplets could be equipped with sensors that feature velocity and/or aftertouch sensitivities, similar to the keys found on many MIDI piano keyboards. Standard electromechanical sensor designs understood by those skilled in the art could be used for this purpose, and changes to the data processing and communications apparatus of the interface could be made to accommodate this additional data.

Different forms of adjustment could be incorporated into an alternative embodiment. For example, an adjustable component could be built into the thumb triplet 118 (see FIG. 3) whereby the distance between the proximal button 312 and the section that includes the distal and medial buttons (310 and 311) could be altered. Alternatively, a mechanism could be included that alters the position of the entire thumb triplet relative to the palm enclosure, allowing movement of the thumb triplet forward and back and/or rotating the thumb triplet in the pitch plane. The ranges of adjustment described in the first embodiment could be increased or reduced, or various types of adjustment could be eliminated entirely. Additionally, embodiments could be produced in different sizes to fit different-sized hands. Another alternative embodiment could use a modular design, where the rear enclosure 120 (see FIG. 1), including its contents, is detachable from the rest of the interface. This detachable rear enclosure would be compatible with a range of front sections of the interface (palm enclosure 115, the finger/thumb triplets, etc) designed to fit different sized hands. In this instance the rear enclosure would also have standard means of forming a secure structural and electronic connection with these front sections. With regard to the finger and thumb triplets (110, 111, 112, 113, and 118), these could also be made in different sizes, with or without the adjustability mechanisms described for the finger triplets in the first embodiment. These different-sized triplets could be interchangeable, and swapped in and out of the interface, with standard means for connecting each triplet's button sensor wiring, to provide the best fit for an individual user. For example, the finger triplets could be swapped in/out at their connection to the triplet track 114. This would assist not only in accommodating a large range of hand sizes, but also the size differences between the fingers of an individual hand.

A variety of alternative embodiments are possible in relation to the electronics of the interface. For example, the data processing functions performed by the processor 817 (see FIG. 8) and/or the button sensor relay 812 could be performed by a processor component added to the external wireless link 819 and/or additional software installed on the recipient device 820 (in the instance where that device is a computer of some type). In this embodiment the data sent from the interface would be in a less processed state, but one that would allow all the necessary processing to take place at these subsequent points in the data chain. This embodiment might have the advantage of reducing the interface's power consumption and making changes to the data-processing algorithms more convenient for the user.

Another alternative embodiment could relocate the electronics housed in the rear enclosure 120 (see FIG. 1) to the palm enclosure 115, and eliminate the rear enclosure altogether. In this embodiment no part of the interface would extend beyond the palm of the user's hand. While this embodiment would lose the counterweight effect of the rear enclosure, it might be useful for applications where the physical presence of a rear enclosure is undesirable. Options for variations in an embodiment's electronics also include reducing the number of axes of measurement among its motion/orientation sensors. For example, an embodiment could lack axes in the roll plane for the acceleration 814 and angular rate sensors 815, or it could lack a magnetic field sensor 816 entirely, etc. Alternatively, additional sensors could be added to the interface, like a GPS receiver, or a receiver for higher-resolution positioning signals, those developed by Locata Corporation Pty Ltd of Canberra, ACT, Australia, being one example.

Another option for an alternative embodiment would be to include audio synthesis/production components within the interface itself. In this embodiment the interface would be able to produce audible musical sounds without assistance from any other devices. Another possibility would be to include a system within the interface that provides haptic feedback to the user. In this embodiment one or more vibration motors could be included within the palm enclosure 115 (see FIG. 1) and information could be provided to the user through their activation. This information could be generated on board the interface by its processing components (e.g. the processor 817, see FIG. 8) or other sources (e.g. the recipient device 820, or a processing component added to the external wireless link 819, etc).

### Interpretation

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Although the present invention has been described with particular reference to certain preferred embodiments thereof, variations and modifications of the present invention can be effected within the spirit and scope of the following claims.

1. A hand operated input device including:
a series of activation points activated by the fingers of a user;
a motion sensor measuring a current orientation of the users hand; and
a processing means interconnected to the activation points and the motion sensors for output, in a substantially continuous manner, a series of currently active activation points and the orientation of the input device.

2. A hand operated input device as claimed in claim 1 wherein the number of activation points per finger is at least two points, with the points being spaced apart from one another for interaction with different portions of a user' s finger.

3. A hand operated input device as claimed in claim 1 wherein the number of activation points per finger is at least 3.

4. A hand operated input device as claimed in claim 1 wherein the fingers of a user include the thumb.

5. A hand operated input device as claimed in claim 1 wherein the motion sensors include orientation sensors sensing the rate of angular rotation of the device.

6. A hand operated input device as claimed in claim 5 wherein said motion sensor outputs a roll, pitch and yaw indicator of the device.

7. A hand operated input device as claimed in claim 1 wherein the motion sensors include position sensors sensing any relative movement of the device.

8. A hand operated input device as claimed in claim 1 wherein said device further includes a weighted elongated portion counterbalancing the activation points when in use by a user.

9. A hand operated input device as claimed in claim 1 wherein the relative position of the activation points is adjustable for each finger.

10. A hand operated input device as claimed in claim 1 wherein the activation points are formed from microswitches.

11. A hand operated input device as claimed in claim 1 wherein said processing means is interconnected to a wireless transmission means for wireless transmission of the output.

12. A hand operated input device as claimed in claim 1 wherein each of the activation points can be actuated either individually or in combination with other activation points.

13. A hand operated input device as claimed in claim 1 wherein the activation points are mapped to notes on a chromatic scale.

14. A hand operated input device as claimed in claim 1 wherein one axis of the orientation of the device is mapped to output the octave of a note's pitch.

15. A hand operated input device as claimed in claim 1 wherein one axis of the orientation of the device is mapped to a series of zones.

16. At least two hand operated input devices, each device including:
a series of activation points activated by the fingers of a user;
a motion sensor measuring a current orientation of the users hand; and
a processing means interconnected to the activation points and the motion sensors for the orientation of the input device;
wherein a further processing unit is provided interconnected to each processing means of each device and calculating a differential output between the hand operated input devices.

17. (canceled)
